(19) United States
(12) Patent Application Publication
(10) Pub. No.: US 2024/0246031 A1
(43) Pub. Date: Jul. 25, 2024

(54) GAS LIQUID EXTRACTION SYSTEM, METHOD, AND CONTACTOR THEREFOR

(71) Applicant: PENTAIR, INC., Minneapolis, MN (US)

(72) Inventors: Evan Lowry, Conroe, TX (US); Yanxiao Yuan, Conroe, TX (US)

(21) Appl. No.: 18/562,794

(22) PCT Filed: May 20, 2022
(86) PCT No.: PCT/US2022/030291

§ 371 Date: Nov. 20, 2023

Related U.S. Application Data
(60) Provisional application No. 63/201,956, filed on May 20, 2021.

(51) Int. Cl. B01D 53/78; B01D 45/16; B01D 53/14; B01D 53/18; B01D 53/62

(52) U.S. Cl. CPC B01D 53/78; B01D 45/16; B01D 53/1475; B01D 53/185; B01D 53/62; B01D 2251/304; B01D 2251/604; B01D 2257/504

(57) ABSTRACT

A contactor is provided. The contactor includes (i) an annular wall defining an annular passageway having a diameter, the diameter at a first end of the annular passageway being greater than the diameter at a second end of the annular passageway; (ii) a plurality of channels extending along a length of an inner surface of the annular wall, the channels extending in a helical pattern along the length of the inner surface; and (iii) a plurality of pins positioned at the second end of the annular passageway, each pin having a length that extends from and aligns with a channel. Also provided is a system and method for extracting liquid-soluble compounds from a gas stream.

### CROSS-REFERENCE TO RELATED APPLICATIONS

This application claims priority to U.S. Provisional Patent Application Ser. No. 63/201,956, filed on May 20, 2021, entitled “GAS LIQUID EXTRACTION SYSTEM, METHOD, AND CONTACTOR THEREFOR,” currently pending, the entire disclosure of which is incorporated herein by reference.

### BACKGROUND

Gases such as natural gas and flue gas oftentimes include contaminants such as carbon dioxide, hydrogen sulfide, and hydrogen chloride. The removal of these contaminants is necessary before the gases can be used by consumers (for example, as an energy source).

Attempts have been made to remove the contaminants by contacting the gas with a solvent that can absorb the contaminants. However, a known challenge with this process is that the solvent (typically provided in a liquid form) tends to coalesce on the walls of piping and process equipment through which the gas/solvent mixture flows. The coalescing of the solvent results in a low interfacial area between the gas and the solvent, which in turn causes inefficient absorption of the contaminants into the solvent. Another known challenge with this process is that the solvent must be efficiently separated from the gas after the contaminants are absorbed by the solvent before the gas is suitable for use by consumers.

The art recognizes the need for an apparatus, system, and method for extracting liquid-soluble compounds from a contaminated gas stream that suspends droplets of solvent in the contaminated gas stream to maximize the interfacial area between the contaminated gas and solvent. The art also recognizes the need for an apparatus, system, and method that efficiently separates the solvent from de-contaminated gas.

### SUMMARY

A contactor is provided. The contactor preferably includes (i) an annular wall defining an annular passageway having a diameter, the diameter at a first end of the annular passageway being greater than the diameter at a second end of the annular passageway; (ii) a plurality of channels extending along a length of an inner surface of the annular wall, the channels extending in a helical pattern along the length of the inner surface; and (iii) a plurality of pins positioned at the second end of the annular passageway, each pin having a length that extends from and substantially aligns with a channel. In alternative embodiments, the contactor may not include each feature (i)-(iii), but rather may only include one or two of the aforementioned features.

In other embodiments, the contactor may comprise: (i) an annular wall defining an annular passageway having a first end and a second end; (ii) a plurality of channels extending along a length of an inner surface of the annular wall, the plurality of channels extending along the length of the inner surface; and (iii) a plurality of pins positioned at the second end of the annular passageway, each pin having a length that extends from and substantially aligns with a channel of the plurality of channels.

A system for extracting liquid-soluble compounds from a gas stream is provided. The system includes (A) a contactor; (B) a gas feed stream comprising a gas and liquid-soluble compounds, the gas feed stream in fluid communication with the first end of the contactor; (C) a solvent feed stream comprising a solvent, the solvent feed stream in fluid communication with the first end of the contactor; and (D) a separation device in fluid communication with the second end of the contactor, the separation device configured to separate gas from solvent comprising the liquid-soluble compounds. Preferably, the contactor may include at least one of the following: (i) an annular wall defining an annular passageway having a diameter, the diameter at a first end of the annular passageway being greater than the diameter at a second end of the annular passageway; (ii) a plurality of channels extending along a length of an inner surface of the annular wall; and (iii) a plurality of pins positioned at the second end of the annular passageway, each pin having a length that extends from and substantially aligns with a channel.

A method for extracting liquid-soluble compounds from a gas stream is provided. The method includes (A) providing a gas feed stream comprising a gas and liquid-soluble compounds; (B) injecting a solvent into the gas feed stream to form a mixed stream; (C) passing the mixed stream through a contactor; (D) forming droplets comprising the solvent with the plurality of pins; (E) absorbing the liquid-soluble compounds into the droplets to form contaminated droplets; and (F) separating the contaminated droplets from the gas. Preferably, the contactor comprises at least one of the following: (i) an annular wall defining an annular passageway having a diameter, the diameter at a first end of the annular passageway being greater than the diameter at a second end of the annular passageway; (ii) a plurality of channels extending along a length of an inner surface of the annular wall, the channels extending in a helical pattern along the length of the inner surface; and (iii) a plurality of pins positioned at the second end of the annular passageway, each pin having a length that extends from and substantially aligns with a channel.

In other embodiments, the method for extracting liquid-soluble compounds from a gas stream may comprise the steps of: (A) providing a gas feed stream; (B) injecting a solvent into the gas feed stream to form a mixed stream; and (C) passing the mixed stream through a contactor. In additional embodiments, the method may further comprise: (D) forming droplets comprising the solvent with the plurality of pins; (E) absorbing liquid-soluble compounds into the droplets to form contaminated droplets; and (F) separating the contaminated droplets from the gas feed stream. In alternative embodiments, steps (D) of the method may comprise forming droplets comprising the solvent using the contactor.

In some embodiments, the annular passageway of the contactor may have a diameter, and the diameter at the first end of the annular passageway may be greater than the diameter at the second end of the annular passageway.

In some embodiments, the plurality of channels protrude radially inward from the annular wall.

In some embodiments, the plurality of channels extend along the length of the inner surface in a pattern, and the pattern is selected from the group consisting of a helical pattern, a parallel pattern, a sinusoidal pattern, and combinations thereof.

In some embodiments, each channel has a cross-sectional shape selected from the group consisting of a polygonal shape, an ellipse, and combinations thereof.

In some embodiments, the annular wall has a wall length; and a ratio of the wall length to the diameter of the annular passageway at the second end is from about 0.5 to about 1.5.

In some embodiments, each pin of the plurality of pins has a cross-sectional shape selected from the group consisting of an ellipse, a circle, a polygon, and combinations thereof. In further embodiments, the cross-sectional shape of each pin of the plurality of pins is the same.

In some embodiments, each channel has a bottom surface, each pin has a top surface, and each channel bottom surface is aligned with a pin top surface.

In some embodiments, the number of channels provided in the plurality of channels is equal to a number of pins provided in the plurality of pins.

In some embodiments, the inner surface of the annular wall has a taper angle of from about 5° to less than about 90°.

In some embodiments, the separation device includes: (i) a bulk separation device in fluid communication with the second end of the contactor; and (ii) a coalescer in fluid communication with the bulk separation device; wherein the bulk separation device and the coalescer are configured to separate gas from solvent comprising the liquid-soluble compounds.

In some embodiments, an injector places the solvent feed stream in fluid communication with the first end of the contactor.

In some embodiments, the contactor is configured to provide a droplet nucleation site.

In some embodiments, the plurality of pins are configured to provide a droplet nucleation site. In further embodiments, the droplet nucleation site may be provided for a liquid solvent.

In some embodiments, the plurality of pins are configured to provide a droplet nucleation site for a stream comprising a gas phase and a liquid phase flowing through the contactor.

### DESCRIPTION OF THE DRAWINGS

FIG. 1 is a right side elevation view of a contactor according to one embodiment.

FIG. 2 is a cross-sectional view of the contactor taken along line C-C of FIG. 1 according to an embodiment.

FIG. 3 is a front elevational view of a contactor according to an embodiment.

FIG. 4 is a cross-sectional view of the contactor taken along line B-B of FIG. 3 according to an embodiment.

FIG. 5 is a rear isometric view of the contactor according to an embodiment.

FIG. 6 is an enlarged front isometric view of the contactor according to an embodiment.

FIG. 7 is a rear elevational view of a contactor according to an embodiment.

FIG. 8 is a front isometric view of a contactor according to an embodiment.

FIG. 9 is a cross-sectional side view of a contactor disposed within a pipe according to another embodiment.

FIG. 10 schematically illustrates a system for extracting liquid-soluble compounds from a gas stream according to another embodiment.

FIG. 11A is a top plan view of an injector according to an embodiment.

FIG. 11B is a top plan view of an injector according to another embodiment.

FIG. 12A is a top plan view of a bulk separation device according to an embodiment.

FIG. 12B is a top plan view of a bulk separation device according to another embodiment.

FIG. 12C is a top plan view of a bulk separation device according to another embodiment.

FIG. 12D is a top plan view of a bulk separation device according to another embodiment.

FIG. 12E is a top plan view of a bulk separation device according to another embodiment.

FIG. 13 schematically illustrates a method for extracting liquid-soluble compounds from a gas stream according to an embodiment.

FIG. 14 is a graph showing the relationship between volumetric mass transfer rate and gas velocity for the examples of the present disclosure.

FIG. 15 is a graph showing the average calculated equivalent droplet size of the droplets produced by the examples of the present disclosure.

FIG. 16 is a graph showing the amount of liquid removed by the bulk separation devices, based on the total volume of liquid present in the stream, for the examples of the present disclosure.

FIG. 17A is a front isometric view of a contactor shown in partial phantom lines according to an embodiment.

FIG. 17B is a rear isometric view of the contactor of FIG. 17A.

FIG. 17C is a side elevational view of the contactor of FIG. 17A.

FIG. 17D is a further side elevational view of the contactor of FIG. 17A.

FIG. 17E is a cross-sectional view taken along line B-B of FIG. 17D.

FIG. 17F is an enlarged view of portion C of FIG. 17E.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

The term “composite” refers to a component formed from more than one distinct piece (or part), which upon assembly are combined.

The term “integral” refers to a component formed from one, and only one, piece of rigid material, such as an injection-molded piece.

The term “line” refers to a physical connection between two points. Nonlimiting examples of suitable lines include tubes and pipes. The term “stream” refers to the composition, mixture, or component, contained within and/or passing through a line. It is understood that the terms “line” and “stream” may be used interchangeably herein, such that, for example, the feed line may be referred to herein as the feed stream (and vice versa).

A “polymer” is a macromolecular compound prepared by polymerizing monomers of the same or different type. “Polymer” includes homopolymers, copolymers, terpolymers, interpolymers, and so on. An “interpolymer” is a polymer prepared by the polymerization of at least two types of monomers or comonomers. It includes, but is not limited to, copolymers (which usually refers to polymers prepared from two different types of monomers or comonomers, terpolymers (which usually refers to polymers prepared from three different types of monomers or comonomers), tetrapolymers (which usually refers to polymers prepared from four different types of monomers or comonomers), and the like.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

A contactor is provided. The contactor includes (i) an annular wall defining an annular passageway having a diameter, the diameter at a first end of the annular passageway being greater than the diameter at a second end of the annular passageway; (ii) a plurality of channels extending along a length of an inner surface of the annular wall, the channels extending in a helical pattern along the length of the inner surface; and (iii) a plurality of pins positioned at the second end of the annular passageway, each pin having a length that extends from and substantially aligns with a channel. In alternative embodiments, the contactor may not include each feature (i)-(iii), but rather may only include one or two of the aforementioned features.

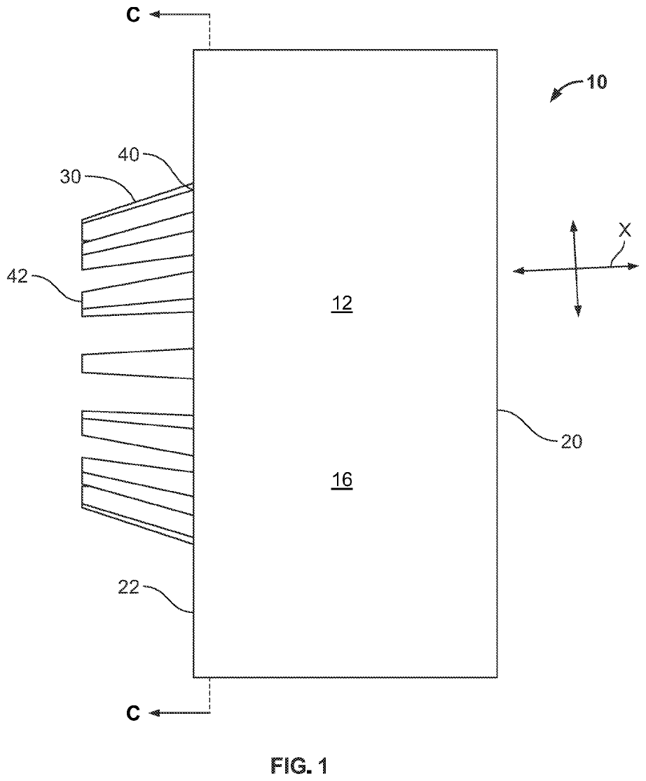

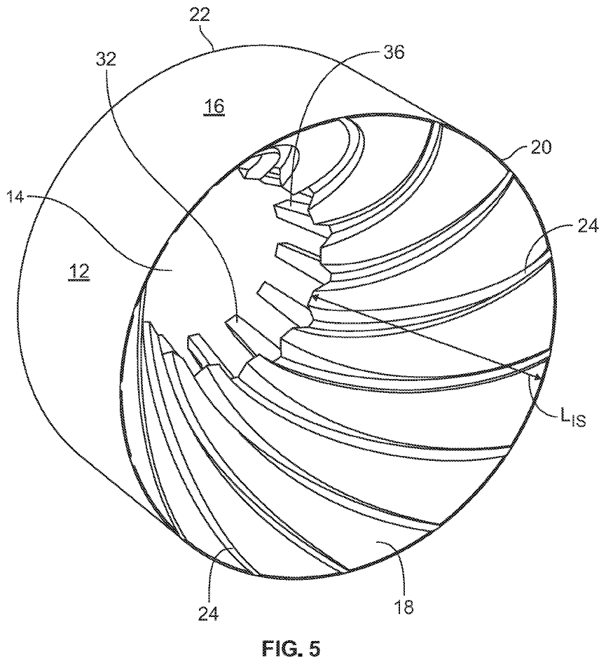

Referring now to FIG. 1, a contactor 10 is shown. A “contactor,” as used herein, is provided in the form of an elongated tube-shaped structure having an annular wall 12. The annular wall 12 defines an annular passageway 14 (illustrated in FIG. 5) extending therethrough. The annular wall 12 may be a single-layer structure or a multi-layer structure. A liquid, a gas, or a solid is provided through, or otherwise disposed within, the annular passageway 14 as the liquid, gas, or solid flows through the contactor 10. The annular wall 12 has opposing surfaces—an outer surface 16 and an inner surface 18—as shown in FIG. 1. The annular wall 12 has a first end 20 and a second end 22 disposed opposite the first end 20. The first end of the annular wall 12 is co-terminus with the first end of the annular passageway 14 and are referred to collectively herein as the first end 20. The second end of the annular wall 12 is co-terminus with the second end of the annular passageway 14 and are referred to collectively herein as the second end 22.

The annular passageway 14 is defined by a diameter dimension, D. The diameter dimension, D₁, at the first end 20 of the annular passageway 14 is greater than the diameter dimension, D₂, at the second end 22 of the annular passageway 14. In other words, the distance D₁ is greater than the distance D₂. Thus, the annular passageway 14 is provided with a conical shape.

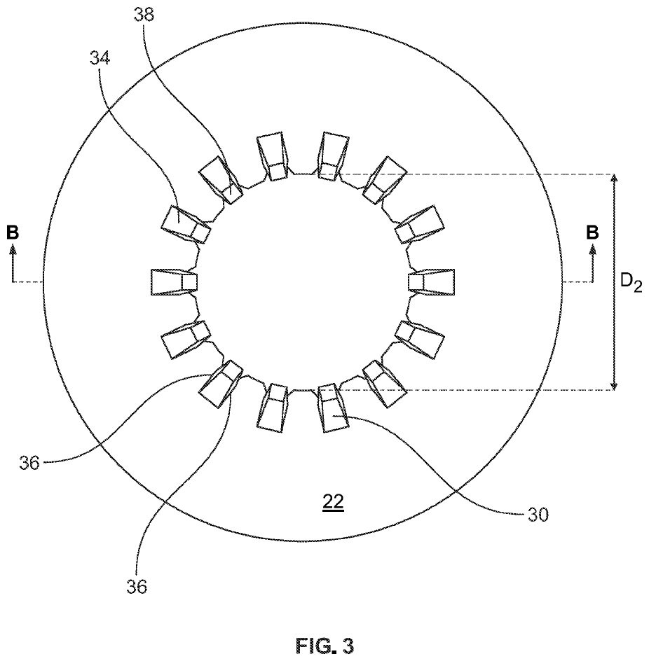

The diameter, D₂, at the second end 22 of the annular passageway 14 is shown in FIG. 3. In an embodiment, the diameter, D₂, at the second end 22 of the annular passageway 14 is at least 0.1 inch (2.45 mm), or at least 0.2 inch (5.08 mm), or at least 0.4 inch (10.16 mm). In another embodiment, the diameter, D₂, at the second end 22 of the annular passageway 14 is from 0.1 inch (2.45 mm) to 12 inches (304.8 mm), or from 0.1 inch (2.45 mm) to 6 inches (152.4 mm), or from 0.1 inch (2.45 mm) to 4 inches (101.6 mm), or from 0.1 inch (2.45 mm) to 2 inches (50.8 mm), or from 0.1 inch (2.45 mm) to 1 inch (25.4 mm), or from 0.1 inch (2.45 mm) to 0.5 inch (12.7 mm), or from 0.2 inch (5.08 mm) to 0.5 inch (12.7 mm), or from 0.4 inch (10.16 mm) to 0.5 inch (12.7 mm). In a further embodiment, the diameter, D₂, at the second end 22 of the annular passageway 14 is 0.43 inch (10.922 mm).

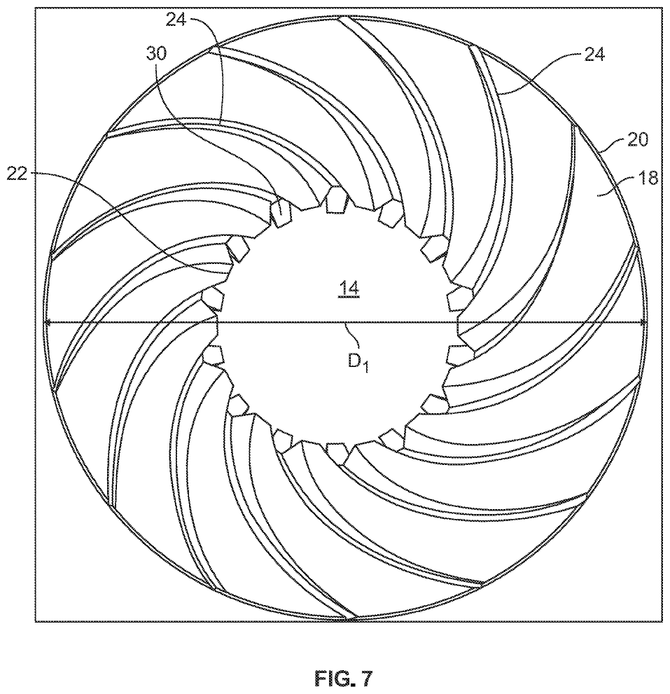

The diameter, D₁, at the first end 20 of the annular passageway 14 is illustrated in FIG. 7. In an embodiment, the diameter, D₁, at the first end 20 of the annular passageway 14 is at least 0.5 inch (12.7 mm), or at least 0.7 inch (17.78 mm), or at least 1 inch (25.4 mm). In another embodiment, the diameter, D₁, at the first end 20 of the annular passageway 14 is from 0.5 inch (12.7 mm) to 24 inches (609.6 mm), or from 0.5 inch (12.7 mm) to 12 inches (304.8 mm), or from 0.5 inch (12.7 mm) to 10 inches (254 mm), or from 0.5 inch (12.7 mm) to 5 inches (127 mm), or from 0.5 inch (12.7 mm) to 2 inches (50.8 mm), or from 0.7 inches (17.78 mm) to 2 inches (50.8 mm), or from 1 inch (25.4 mm) to 2 inches (50.8 mm).

The contactor 10 includes a plurality of channels 24 extending along a length, L_{IS}, of the inner surface 18 of the annular wall 12, as shown in FIG. 5. Each channel 24 extends along the entire length L_{IS}, or substantially the entire length L_{IS}, of the inner surface 18 of the annular wall 12. In an embodiment, each channel 24 extends along the entire length, L_{IS}, of the inner surface 18 of the annular wall 12.

In an embodiment, the channels 24 extend along the entire length, L_{IS}, of the inner surface 18 of the annular wall 12 in a helical pattern. In alternate embodiments, the channels 24 extend along the entire length, L_{IS}, of the inner surface 18 of the annular wall 12 in a helical pattern, a parallel pattern, a sinusoidal pattern, or a combination thereof. In an embodiment, one or more channels 24 may intersect, or otherwise contact one another. In a further embodiment, the channels 24 intersect in a criss-cross pattern. In another embodiment, the channels 24 do not intersect or otherwise contact one another.

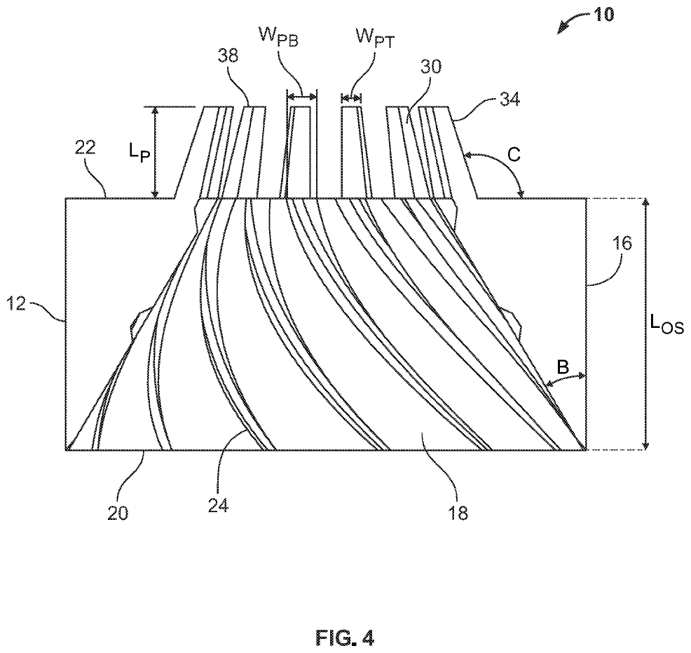

In an embodiment, the plurality of channels 24 extend along the length, L_{IS}, of the inner surface 18 of the annular wall 12 in a helical pattern. The term “helical,” as used herein, refers to channels extending in a spiral manner along the length, L_{IS}, on and around the inner surface 18 of the annular wall 12, and not intersecting. FIGS. 4, 5, and 7 depict channels 24 that extend along the entire length, L_{IS}, of the inner surface 18 of the annular wall 12 in a helical pattern.

In an embodiment, the plurality of channels 24 extend along the length, L_{IS}, of the inner surface 18 of the annular wall 12 in a parallel pattern (not illustrated). The term “parallel,” as used herein, refers to channels extending in the same direction along the length, L_{IS}, of the inner surface 18 of the annular wall 12, the channels 24 maintaining a parallel orientation with respect to longitudinal axis, X, as shown in FIG. 1. The parallel channels do not intersect each other.

In an embodiment, the plurality of channels 24 extend along the length, L_{IS}, of the inner surface 18 of the annular wall 12 in a sinusoidal pattern (not shown). The term “sinusoidal,” as used herein, refers to channels extending in a sinusoidal or wave-like manner along the length, L_{IS}, of the inner surface 18 of the annular wall 12. In a further embodiment, the sinusoidal pattern is composed of non-intersecting channels 24.

The channels 24 are arranged in a spaced-apart manner along the inner surface 18 of the annular wall 12. In an embodiment, the channels 24 are each spaced an equal distance from one another. FIGS. 4, 5, and 7 depict channels 24 that are each spaced an equal distance from one another.

In an embodiment, the contactor 10 includes at least 2, or at least 4, or at least 6, or at least 8, or at least 10, or at least 12 channels 24. In another embodiment, the contactor 10 includes from 2, or 4, or 6, or 8, or 10, or 12, or 14 to 16, or 18, or 20, or 22, or 24, or 26, or 28, or 30, or 40, or 50 channels 24. In a further embodiment, the contactor 10 includes from 2 to 50, or from 2 to 40, or from 2 to 30, or from 2 to 20, or from 8 to 20, or from 10 to 20, or from 12 to 20, or from 14 to 20, or from 10 to 18, or from 10 to 16, or from 10 to 14 channels 24. The contactor 10 may have an even number of channels (e.g., 14, 16, etc.) or an odd number of channels (e.g., 13, 15, etc.). In an embodiment, the contactor 10 includes 14 channels 24.

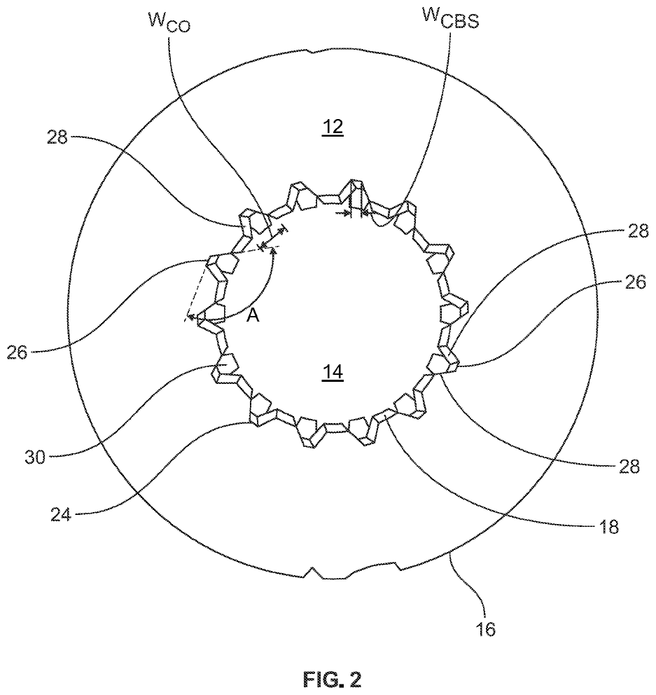

Each channel 24 is defined by a channel structure. A “channel structure” is a void having a width and a depth that is defined by the annular wall 12. Each channel 24 protrudes radially inward from the annular wall 12. A channel 24 that “protrudes radially inward from the annular wall” has a structure that extends inward beyond the inner surface 18 of the annular wall 12, as shown in FIG. 2.

The channel structure of the channel 24 has a cross-sectional shape. Nonlimiting examples of suitable cross-sectional shapes for the channel structure include an ellipse, a polygon, and combinations thereof. Each channel 24 may have the same cross-sectional shape or different cross-sectional shapes. In an embodiment, each channel 24 has the same cross-sectional shape.

In an embodiment, the channel structure of the channel 24 has a polygon cross-sectional shape. A “polygon” is a figure bounded by at least three sides. The polygon can be a regular polygon or an irregular polygon having three, four, five, six, seven, eight, nine, ten, or more than ten sides. Nonlimiting examples of suitable polygonal shapes include a triangle, a square, a rectangle, a diamond, a trapezoid, a parallelogram, a hexagon and an octagon. FIG. 2 depicts channel structures that have a trapezoidal cross-sectional shape.

In an embodiment, the channel structure of the channel 24 has an ellipse cross-sectional shape (not shown). An “ellipse” is a plane curve such that the sum of the distances of each point in its periphery from two fixed points, the foci, are equal. The ellipse has a center which is the midpoint of the line segment linking the two foci. The ellipse has a major axis (the longest diameter through the center) and a minor axis (the shortest diameter through the center). The ellipse center is the intersection of the major axis and the minor axis. A “circle” is a specific form of ellipse, where the two focal points are in the same place (at the circle's center). Nonlimiting examples of ellipse shapes include circle, oval, and ovoid.

In an embodiment, the channel structures of the channels 24 have a cross-sectional shape that is a circle, a triangle, a trapezoid, a diamond, or a combination thereof.

Referring to FIG. 2, each channel 24 has a bottom surface 26 and opposing side surfaces 28. The bottom surface 26 extends between and contacts the opposing side surfaces 28. Each channel 24 bottom surface 26 has a width, W_{CBS}. In an embodiment, the channel 24 bottom surface 26 has a width, W_{CBS}, of at least 0.001 inches (0.0254 mm), or at least 0.01 inches (0.254 mm), or at least 0.02 inches (0.508 mm). In another embodiment, the channel 24 bottom surface 26 has a width, W_{CBS}, of from 0.001 inches (0.0254 mm) to 2 inches (50.8 mm), or from 0.001 inches (0.0254 mm) to 1 inch (25.4 mm), or from 0.001 inches (0.0254 mm) to 0.5 inch (12.7 mm), or from 0.001 inches (0.0254 mm) to 0.1 inch (2.54 mm), or from 0.01 inches (0.254 mm) to 0.1 inch (2.54 mm), or from 0.02 inches (0.508 mm) to 0.1 inch (2.54 mm), or from 0.01 inches (0.254 mm) to 0.02 inches (0.508 mm). In another embodiment, each channel 24 bottom surface 26 has a width, W_{CBS}, of 0.02 inches (0.508 mm). The width, W_{CBS}, of each channel 24 may be the same or different. In an embodiment, each channel 24 has the same width, W_{CBS}. In another embodiment, one or more channels 24 have different widths, W_{CBS}.

Each channel 24 has an opening opposite the bottom surface 26 that is defined by the opposing side surfaces 28. The channel 24 opening is co-planar with the inner surface 18 of the annular wall 12. The channel 24 opening puts the channel in fluid communication with the annular passageway 14.

In an embodiment, each channel 24 opening has a width, W_{CO}, as shown in FIG. 2. The channel 24 opening width, W_{CO}, may be the same or different than the channel 24 bottom surface 26 width, W_{CBS}. In an embodiment, the channel 24 opening width, W_{CO}, is the same as the channel 24 bottom surface 26 width, W_{CBS}. In another embodiment, the channel 24 opening width, W_{CO}, is different than (e.g., more or less than) the channel 24 bottom surface 26 width, W_{CBS}. In a further embodiment, the channel 24 opening width, W_{CO}, is greater than the channel 24 bottom surface 26 width, W_{CBS}.

In some embodiments, the channel 24 has an opening width, W_{CO}, of at least 0.001 inches (0.0254 mm), or at least 0.01 inches (0.254 mm), or at least 0.02 inches (0.508 mm), or at least 0.05 inch (1.27 mm), or at least 0.06 inch (1.524 mm). In another embodiment, the channel 24 has an opening width, W_{CO}, of from 0.001 inches (0.0254 mm) to 3 inches (76.2 mm), or from 0.001 inches (0.0254 mm) to 2 inches (50.8 mm), or from 0.001 inches (0.0254 mm) to 1 inch (25.4 mm), or from 0.001 inches (0.0254 mm) to 0.5 inch (12.7 mm), or from 0.001 inches (0.0254 mm) to 0.1 inch (2.54 mm), or from 0.01 inches (0.254 mm) to 0.1 inch (2.54 mm), or from 0.02 inches (0.508 mm) to 0.1 inch (2.54 mm), or from 0.01 inches (0.254 mm) to 0.08 inches (2.032 mm), or from 0.02 inches (0.508 mm) to 0.1 inch (2.54 mm), or from 0.06 inch (1.524 mm) to 0.1 inch (2.54 mm), or from 0.06 inch (1.524 mm) to 0.08 inches (2.032 mm). In a further embodiment, each channel 24 has an opening width, W_{CO}, of 0.062 inches (1.5748 mm). The width, W_{CO}, of each channel 24 may be the same or different. In an embodiment, each channel 24 has the same opening width, W_{CO}. In another embodiment, one or more channels 24 have different opening widths, W_{CO}.

Referring to FIG. 2, the opposing side surfaces 28 of the channel 24 extend at an angle A from the bottom surface 26 of the channel 24. In some embodiments, the angle, A, is obtuse, a right angle, or acute. In additional embodiments, the angle A is at least 90°, or at least 100°, or at least 110°, or at least 120°. In an embodiment, the angle, A, is from 90°, or greater than 90°, or 95°, or 100°, or 110°, or 115°, or 1200 to 125°, or 130°, or 140°, or 150°, or 160°, or 170°, or less than 180°. In another embodiment, the angle, A, is from 900 to less than 180°, or from greater than 900 to less than 180°, or from greater than 900 to 160°, or from greater than 900 to 140°, or from 100° to 140°, or from 110° to 130°, or from 115° to 125°, or from 100° to 120°, or from 1200 to 160°. In a further embodiment, the angle, A, is 120°. The angle, A, of each channel 24 may be the same or different. In an embodiment, each channel 24 has the same angle, A. In another embodiment, one or more channels 24 have a different angle, A.

The outer surface 16 of the annular wall 12 has a length, L_{OS}, as shown in FIG. 4. In some embodiments, the outer surface 16 of the annular wall 12 has a length, L_{OS}, of at least 0.2 inches (5.08 mm), or at least 0.4 inches (10.16 mm), or at least 0.5 inches (12.7 mm). In an embodiment, the outer surface 16 of the annular wall 12 has a length, L_{OS}, of from 0.2 inches (5.08 mm) to 24 inches (609.6 mm), or from 0.2 inches (5.08 mm) to 12 inches (304.8 mm), or from 0.2 inches (5.08 mm) to 6 inches (152.4 mm), or from 0.2 inches (5.08 mm) to 2 inches (50.8 mm), or from 0.2 inches (5.08 mm) to 1 inch (25.4 mm), or from 0.4 inches (10.16 mm) to 1 inch (25.4 mm), or from 0.5 inches (12.7 mm) to 1 inch (25.4 mm), or from 0.2 inches (5.08 mm) to 0.5 inches (12.7 mm). In a further embodiment, the outer surface 16 of the annular wall 12 has a length, L_{OS}, of 0.5 inches (12.7 mm).

In an embodiment, a ratio of the length, L_{OS}, of the outer surface 16 of the annular wall to the diameter, D₁, at the first end 20 of the annular passageway 14 (the “L_{OS}:D₁ Ratio”) is from about 0.5 to about 1.5 (or from 0.5 to 1.5), or from about 0.5 to less than about 1(or from 0.5 to less than 1), or from about 0.5 to about 1 (or from 0.5 to 1), or from about 1 to about 1.5 (or from 1 to 1.5). In another embodiment, the L_{OS}:D₁ Ratio is at least about 0.5, or 0.5, or at least about 1, or 1, or at least about 1.5, or 1.5. In some embodiments, the L_{OS}:D₁ Ratio is about 0.5 or 0.5.

Referring to FIG. 4, the inner surface 18 of the annular wall 12 extends at an angle, B, relative to the outer surface 16 of the annular wall 12. In some embodiments, the angle, B, is from greater than 0° to less than 90°, or less than 80°, or less than 70°, or less than 60°, or less than 50°, or less than 45°, or less than 40°, or less than 35°. In another embodiment, the angle, B, is from 5° to less than 90°, or from 5° to 80°, or from 5° to 60°, or from 5° to 50°, or from 5° to 45°, or from 10° to 45°, or from 10° to 40°, or from 20° to 40°, or from 25° to 40°, or from 30° to 40°, or from 30° to 35°. In a further embodiment, the angle, B, is 31°. The angle, B, is also referred to as the taper angle of the inner surface 18 of the annular wall 12.

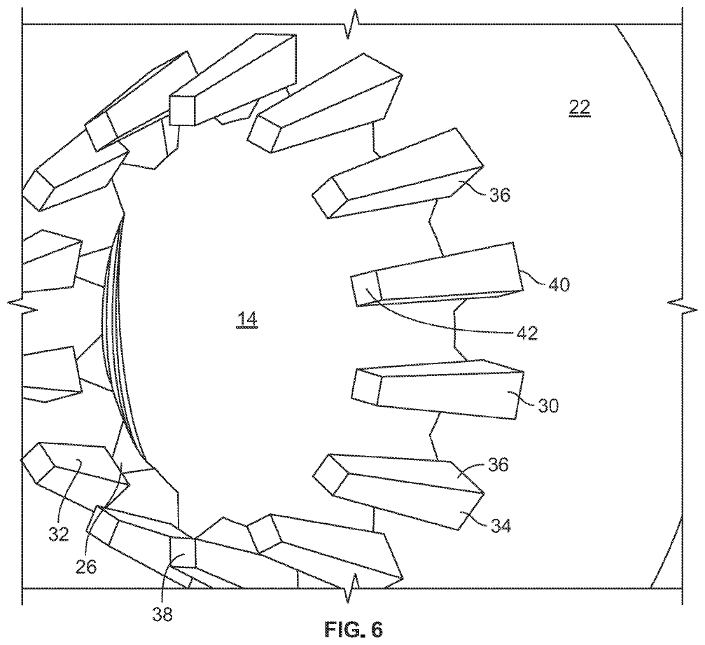

Referring to FIGS. 5 and 6, the contactor 10 further includes a plurality of pins 30 positioned at the second end 22 of the annular passageway 14. Each pin 30 is provided in the form of a top surface 32, a bottom surface 34, two opposing side surfaces 36, and a tip end surface 38. Each side surface 36 extends between the top surface 32 and the bottom surface 34. Each pin 30 has two opposing ends that are the base end 40 and the tip end 42.

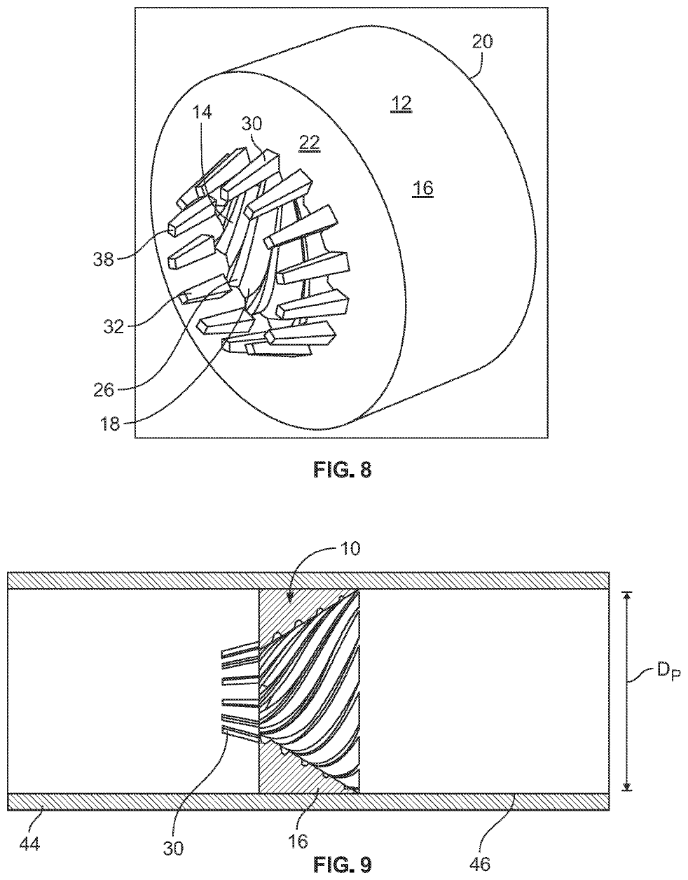

The pins 30 are arranged in a spaced-apart manner and extend from the second end 22 of the annular wall 12. In an embodiment, the pins 30 are each spaced an equal distance from one another. FIGS. 3, 4, 6, and 8 depict pins 30 that are each spaced an equal distance from one another.

In an embodiment, the contactor 10 includes at least 2, or at least 4, or at least 6, or at least 8, or at least 10, or at least 12 pins 30. In another embodiment, the contactor 10 includes 2, or 4, or 6, or 8, or 10, or 12, or 14 to 16, or 18, or 20, or 22, or 24, or 26, or 28, or 30, or 40, or 50 pins 30. In a further embodiment, the contactor 10 includes from 2 to 50, or from 2 to 40, or from 2 to 30, or from 2 to 20, or from 8 to 20, or from 10 to 20, or from 12 to 20, or from 14 to 20, or from 10 to 18, or from 10 to 16, or from 10 to 14 pins 30. The contactor 10 may have an even number of pins (e.g., 14, 16, etc.) or an odd number of pins (e.g., 13, 15, etc.). In an embodiment, the contactor 10 includes fourteen pins 30. In some embodiments, the number of channels 24 is equal to the number of pins 30.

Each pin 30 has a cross-sectional shape. Nonlimiting examples of suitable cross-sectional shapes for the pin shape include an ellipse, a circle, a polygon, and combinations thereof. In some embodiments, the pins 30 have a polygonal cross-sectional shape. Nonlimiting examples of suitable polygonal shapes include triangle, square, rectangle, diamond, trapezoid, parallelogram, hexagon and octagon. In an embodiment, the pins 30 have a cross-sectional shape that is a circle, a triangle, a trapezoid, a square, a rectangle, a diamond, or a combination thereof. The pins 30 may have the same or different cross-sectional shapes. In an embodiment, the pins 30 each have the same cross-sectional shape.

In an embodiment, each channel 24 bottom surface 26 is aligned with the top surface 32 of a pin 30, as shown in FIGS. 2, 6, and 7. In other words, at least a portion of the bottom surface 26 of each channel 24 borders upon and has a common boundary with at least a portion of the top surface 32 of a pin 30. Not wishing to be bound by any particular theory, it is believed that by aligning the bottom surface 26 of the channel 24 with the top surface 32 of a pin 30, liquid (e.g., solvent) passing through the annular passageway 14 will collect into the channels 24 and onto the pins 30 efficiently and smoothly.

Each pin 30 has a length, L_{P}, that extends from and substantially aligns with a channel 24, as shown in FIG. 4. The pin length, L_{P}, is the distance between the base end 40 and the tip end 42. In an embodiment, the pin length, L_{P}, is at least 0.05 inches (1.27 mm), or at least 0.10 inches (2.54 mm), or at least 0.15 inches (3.81 mm), or at least 0.18 inches (4.572 mm). In another embodiment, the pin length, L_{P}, is from 0.05 inches (1.27 mm) to 5 inches (127 mm), or from 0.05 inches (1.27 mm) to 3 inches (76.2 mm), or from 0.05 inches (1.27 mm) to 2 inches (50.8 mm), or from 0.05 inches (1.27 mm) to 1 inch (25.4 mm), or from 0.05 inches (1.27 mm) to 0.50 inches (12.7 mm), or from 0.05 inches (1.27 mm) to 0.30 inches (7.62 mm), or from 0.05 inches (1.27 mm) to 0.20 inches (5.08 mm), or from 0.10 inches (2.54 mm) to 0.20 inches (5.08 mm), or from 0.15 inches (3.81 mm) to 0.20 inches (5.08 mm). In a further embodiment, the pin length, L_{P}, is 0.18 inches (4.572 mm).

Each pin 30 has a base width, W_{PB}, and a tip width, W_{PT}, as shown in FIG. 4. The base width, W_{PB}, and the tip width, W_{PT}, may be the same or different, resulting in the pins 30 being one or more of tapered, thickened, and/or straight along a length thereof. In an embodiment, the base width, W_{PB}, and the tip width, W_{PT}, are different. In a further embodiment, the base width, W_{PB}, is greater than the tip width, W_{PT}. The base width, W_{PB}, and the tip width, W_{PT}, of each pin 30 may be the same or different. In some embodiments, the base width, W_{PB}, and the tip width, W_{PT}, are the same for each pin 30. In a further embodiment, the base width, W_{PB}, and the tip width, W_{PT}, are the same for each pin 30 and the base width, W_{PB}, is greater than the tip width, W_{PT}.

In some embodiments, the pin base width, W_{PB}, is at least 0.01 inches (0.254 mm), or at least 0.04 inches (1.016 mm), or at least 0.06 inches (1.524 mm). In an embodiment, the pin base width, W_{PB}, is from 0.01 inches (0.254 mm) to 2 inches (50.8 mm), or from 0.01 inches (0.254 mm) to 1 inch (25.4 mm), or from 0.01 inches (0.254 mm) to 0.50 inches (12.7 mm), or from 0.01 inches (0.254 mm) to 0.10 inches (2.54 mm), or from 0.04 inches (1.016 mm) to 0.10 inches (2.54 mm), or from 0.05 inches (1.27 mm) to 0.10 inches (2.54 mm), or from 0.06 inches (1.524 mm) to 0.10 inches (2.54 mm). In a further embodiment, the pin base width, W_{PB}, is 0.60 inches (1.524 mm).

The pin base width, W_{PB}, may be the same or different than the channel bottom surface width, W_{CBS}. In some embodiments, the pin base width, W_{PB}, is equal to, or substantially equal to, the channel bottom surface width, W_{CBS}. In other embodiments, pin base width, W_{PB}, is different than the channel bottom surface width, W_{CBS}. In an embodiment, the pin base width, W_{PB}, is greater than the channel bottom surface width, W_{CBS}. In a further embodiment, the ratio of the pin base width, W_{PB}, to the channel bottom surface width, W_{CBS} (or the “W_{PB}:W_{CBS} Ratio”) is at least about 1.5:1 (or 1.5:1), or at least about 2:1(or 2:1), or at least about 2.5:1(or 2.5:1), or at least about 3:1(or 3:1). In some embodiments, the W_{PB}:W_{CBS} Ratio is from about 1.5:1 (or 1.5:1) to about 10:1(or 10:1), or from about 1.5:1 (or 1.5:1) to about 5:1 (or 5:1), or from about 2:1(or 2:1) to about 5:1(or 5:1), or from about 2.5:1 (or 2.5:1) to about 5:1 (or 5:1), or from about 3:1 (or 3:1) to about 5:1 (or 5:1), or from about 1.5:1 (or 1.5:1) to about 3:1(or 3:1). In a further embodiment, the W_{PB}:W_{CBS} Ratio is about 3:1 (or 3:1).

In some embodiments, the pin tip width, W_{PT}, is at least 0.001 inches (0.0254 mm), or at least 0.005 inches (0.127 mm), or at least 0.01 inches (0.254 mm), or at least 0.02 inches (0.508 mm), or at least 0.03 inches (0.762 mm). In an embodiment, the pin tip width, W_{PT}, is from 0.001 inches (0.0254 mm) to 2 inches (50.8 mm), or from 0.001 inches (0.0254 mm) to 1 inch (25.4 mm), or from 0.001 inches (0.0254 mm) to 0.50 inches (12.7 mm), or from 0.001 inches (0.0254 mm) to 0.10 inches (2.54 mm), or from 0.01 inches (0.254 mm) to 0.10 inches (2.54 mm), or from 0.02 inches (0.508 mm) to 0.10 inches (2.54 mm), or from 0.03 inches (0.762 mm) to 0.10 inches (2.54 mm), or 0.03 inches (0.762 mm) to 0.05 inches (1.27 mm). In a further embodiment, the pin tip width, W_{PT}, is 0.03 inches (0.762 mm).

In some embodiments, the ratio of the pin base width, W_{PB} to the pin tip width, W_{PT} (the “W_{PB}:W_{PT} Ratio”) is at least about 1:1 (or 1:1), or at least about 1.5:1 (or 1.5:1), or at least about 2:1(or 2:1). In an embodiment, the W_{PB}:W_{PT} Ratio is from about 1:1 (or 1:1) to about 10:1 (or 10:1), or from greater than about 1:1 (or 1:1) to about 10:1(or 10:1), or from about 1.5:1 (or 1.5:1) to about 10:1 (or 10:1), or from about 1.5:1 (or 1.5:1) to about 5:1 (or 5:1), or from about 1.5:1 (or 1.5:1) to about 2:1(or 2:1), or from about 2:1 (or 2:1) to about 5:1 (or 5:1). In a further embodiment, the W_{PB}:W_{PT} Ratio is about 2:1 (or 2:1).

The pin bottom surface 34 extends at an angle, C, from the second end 22 of the annular wall 12, as shown in FIG. 4. In an embodiment, the angle, C, is from at least 90°, or at least 95°, or at least 100°, or at least 105°, or at least 1080 to less than 180°. In some embodiments, the angle, C, is from 900 to less than 180°, or from 900 to 150°, or from 900 to 120°, or from greater than 900 to less than 180°, or from greater than 900 to 150°, or from greater than 900 to 120°, or from 950 to 120°, or from 1000 to 115°, or from 1050 to 115°, or from 1000 to 110°, or from 1050 to 110°, or from 1080 to 110°. In further embodiments, the angle, C, is about 1080 (or 108°).

In some embodiments, the pin top surface 32 is parallel to the pin bottom surface 34. In other words, the pin top surface 32 extends at an angle from the second end 22 of the annular wall 12 that is equal to the angle, C. In other embodiments, the pin top surface 32 extends at an angle from the second end 22 of the annular wall 12 that is different than the angle, C.

The annular wall 12 and the pins 30 may or may not be formed from the same material. In an embodiment, the annular wall 12 and the pins 30 are formed from the same material. Nonlimiting examples of suitable material include polymers, metals, glass, fiberglass, and combinations thereof. A nonlimiting example of a suitable polymer is polyamide. A nonlimiting example of a suitable metal is stainless steel. Nonlimiting examples of suitable methods to form the contactor 10 include 3D printing, injection molding, metal casting, and combinations thereof.

The annular wall 12 and the pins 30 may be integral or composite components. In an embodiment, the contactor 10 (including the annular wall 12 and the pins 30) is integral. In another embodiment, the annular wall 12 and the pins 30 are composite components that are assembled to form the contactor 10. Nonlimiting examples of suitable methods of assembly include welding, adhering, and combinations thereof.

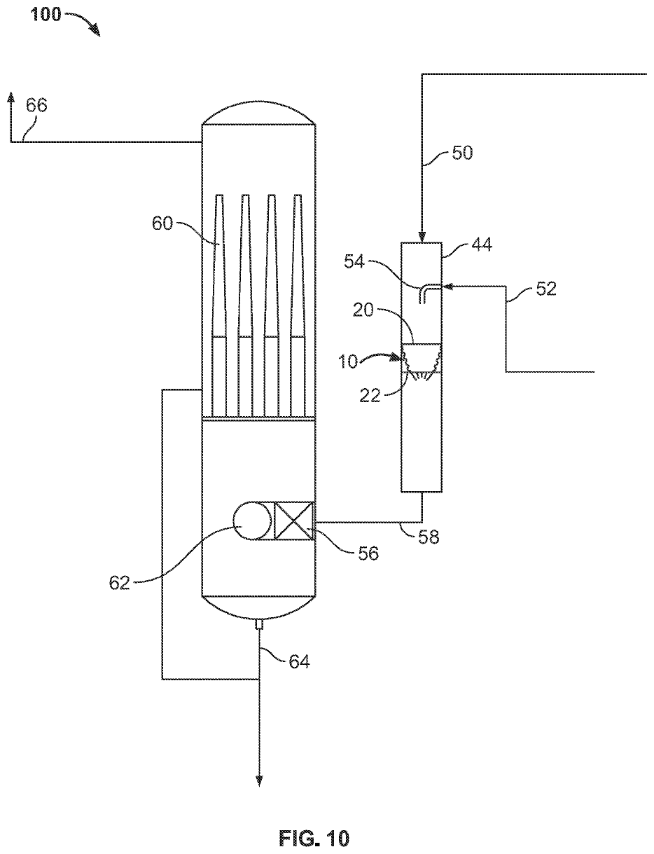

In some embodiments, the contactor 10 may be placed in a conduit or pipe 44, as shown in FIG. 9. The contactor 10 is positioned in the pipe 44 such that the outer surface 16 of the annular wall 12 contacts the inner surface 46 of the pipe 44. In some embodiments, the outer surface 16 of the annular wall 12 is adhered to or welded to (or a combination thereof) the inner surface 46 of the pipe 44. Consequently, a liquid, a gas, or a solid that is extending (or flowing) through, or otherwise disposed within, the pipe 44 also extends through or is otherwise disposed within the annular passageway 14 of the contactor 10.

Not wishing to be bound by any particular theory, it is believed that when a stream containing a gas phase and a liquid phase flows through the annular passageway 14 of the contactor 10 from the first end 20 to the second end 22, the liquid phase will coalesce and re-entrain in the channels 24. The liquid phase then flows through the channels 24 and is directed towards the pins 30 that are aligned with the channels 24. The pins 30 function as droplet nucleation sites (which disperses the liquid phase as droplets into the gas phase) and promote back-mixing of the stream containing a gas phase and a liquid phase to enhance contact time between the liquid phase and the gas phase. Thus, the present contactor 10 increases the interfacial area between the gas phase and the liquid phase by dispersing droplets of the liquid phase within the gas phase. Further, the channels 24 that extend along the annular passageway 14 having a conical shape advantageously increase the velocity of the stream, which can provide for better separation of the liquid phase from the gas phase downstream of the contactor 10.

The pipe 44 has a diameter, D_{P}, as shown in FIG. 9. In some embodiments, the ratio of the length L_{OS} of the outer surface 16 of the annular wall to the pipe diameter D_{P} (the “L_{OS}: D_{P} Ratio”) is no greater than 1:1. In another embodiment, the L_{OS}: D_{P} Ratio is from 0.1:1, or 0.2:1, or 0.4:1, or 0.5:1 to 0.6:1, or 0.8:1, or 0.9:1, or 1:1. In further embodiments, the L_{OS}: D_{P} Ratio is from 0.1:1 to 1:1, or from 0.5:1 to 1:1, or from 0.1:1 to 0.9:1, or from 0.2:1 to 0.8:1, or from 0.4:1 to 0.6:1, or from 0.1:1 to 0.5:1. In some embodiments, the L_{OS}: D_{P} Ratio is 0.5:1.

In an embodiment, the contactor 10 includes (i) an annular wall 12 defining an annular passageway 14 having a diameter, the diameter D₁ at a first end 20 of the annular passageway 14 being greater than the diameter D₂ at a second end 22 of the annular passageway 14; (ii) a plurality of channels 24 extending along a length L_{IS} of an inner surface 18 of the annular wall 12, the channels 24 extending in a helical pattern along the length L_{IS} of the inner surface 18; and (iii) a plurality of pins 30 positioned at the second end 22 of the annular passageway 14, each pin 30 having a length, L_{P}, that extends from and substantially aligns with a channel 24. In an embodiment, the contactor has one, some, or all of the following properties:
(a) the diameter D₁ at the first end 20 of the annular passageway 14 is from 0.5 inch (12.7 mm) to 24 inches (609.6 mm), or from 0.5 inch (12.7 mm) to 12 inches (304.8 mm), or from 0.5 inch (12.7 mm) to 10 inches (254 mm), or from 0.5 inch (12.7 mm) to 5 inches (127 mm), or from 0.5 inch (12.7 mm) to 2 inches (50.8 mm), or from 0.7 inches (17.78 mm) to 2 inches (50.8 mm), or from 1 inch (25.4 mm) to 2 inches (50.8 mm); and/or
(b) the diameter D₂ at the second end 22 of the annular passageway 14 is from 0.1 inch (2.45 mm) to 12 inches (304.8 mm), or from 0.1 inch (2.45 mm) to 6 inches (152.4 mm), or from 0.1 inch (2.45 mm) to 4 inches (101.6 mm), or from 0.1 inch (2.45 mm) to 2 inches (50.8 mm), or from 0.1 inch (2.45 mm) to 1 inch (25.4 mm), or from 0.1 inch (2.45 mm) to 0.5 inch (12.7 mm), or from 0.2 inch (5.08 mm) to 0.5 inch (12.7 mm), or from 0.4 inch (10.16 mm) to 0.5 inch (12.7 mm); and/or
(c) the contactor 10 includes from 2 to 50, or from 2 to 40, or from 2 to 30, or from 2 to 20, or from 8 to 20, or from 10 to 20, or from 12 to 20, or from 14 to 20, or from 10 to 18, or from 10 to 16, or from 10 to 14 channels 24; and/or
(d) each channel 24 has a bottom surface 26 having a width, W_{CBS}, of from 0.001 inches (0.0254 mm) to 2 inches (50.8 mm), or from 0.001 inches (0.0254 mm) to 1 inch (25.4 mm), or from 0.001 inches (0.0254 mm) to 0.5 inch (12.7 mm), or from 0.001 inches (0.0254 mm) to 0.1 inch (2.54 mm), or from 0.01 inches (0.254 mm) to 0.1 inch (2.54 mm), or from 0.02 inches (0.508 mm) to 0.1 inch (2.54 mm), or from 0.01 inches (0.254 mm) to 0.02 inches (0.508 mm); and/or
(e) each channel 24 has an opening width, W_{CO}, of from 0.001 inches (0.0254 mm) to 3 inches (76.2 mm), or from 0.001 inches (0.0254 mm) to 2 inches (50.8 mm), or from 0.001 inches (0.0254 mm) to 1 inch (25.4 mm), or from 0.001 inches (0.0254 mm) to 0.5 inch (12.7 mm), or from 0.001 inches (0.0254 mm) to 0.1 inch (2.54 mm), or from 0.01 inches (0.254 mm) to 0.1 inch (2.54 mm), or from 0.02 inches (0.508 mm) to 0.1 inch (2.54 mm), or from 0.01 inches (0.254 mm) to 0.08 inches (2.032 mm), or from 0.02 inches (0.508 mm) to 0.1 inch (2.54 mm), or from 0.06 inch (1.524 mm) to 0.1 inch (2.54 mm), or from 0.06 inch (1.524 mm) to 0.08 inches (2.032 mm); and/or
(f) the outer surface 16 of the annular wall 12 has a length, L_{OS}, of from 0.2 inches (5.08 mm) to 24 inches (609.6 mm), or from 0.2 inches (5.08 mm) to 12 inches (304.8 mm), or from 0.2 inches (5.08 mm) to 6 inches (152.4 mm), or from 0.2 inches (5.08 mm) to 2 inches (50.8 mm), or from 0.2 inches (5.08 mm) to 1 inch (25.4 mm), or from 0.4 inches (10.16 mm) to 1 inch (25.4 mm), or from 0.5 inches (12.7 mm) to 1 inch (25.4 mm), or from 0.2 inches (5.08 mm) to 0.5 inches (12.7 mm); and/or
(g) the L_{OS}:D₁ Ratio is at least about 0.5, or at least about 1.0, or at least about 1.5; and/or
(h) the taper angle is from about 5° to less than about 90°, or from about 5° to about 80°, or from about 5° to about 60°, or from about 5° to about 50°, or from about 5° to about 45°, or from about 100 to about 45°, or from about 100 to about 40°, or from about 200 to about 40°, or from about 250 to about 40°, or from about 300 to about 40°, or from about 300 to about 35°; and/or
(i) the contactor 10 includes from 2 to 50, or from 2 to 40, or from 2 to 30, or from 2 to 20, or from 8 to 20, or from 10 to 20, or from 12 to 20, or from 14 to 20, or from 10 to 18, or from 10 to 16, or from 10 to 14 pins 30; and/or
(j) each channel 24 bottom surface 26 is aligned with a top surface 32 of a pin 30; and/or
(k) the pin length, L_{P}, is from 0.05 inches (1.27 mm) to 5 inches (127 mm), or from 0.05 inches (1.27 mm) to 3 inches (76.2 mm), or from 0.05 inches (1.27 mm) to 2 inches (50.8 mm), or from 0.05 inches (1.27 mm) to 1 inch (25.4 mm), or from 0.05 inches (1.27 mm) to 0.50 inches (12.7 mm), or from 0.05 inches (1.27 mm) to 0.30 inches (7.62 mm), or from 0.05 inches (1.27 mm) to 0.20 inches (5.08 mm), or from 0.10 inches (2.54 mm) to 0.20 inches (5.08 mm), or from 0.15 inches (3.81 mm) to 0.20 inches (5.08 mm); and/or
(l) the pin base width, W_{PB}, is from 0.01 inches (0.254 mm) to 2 inches (50.8 mm), or from 0.01 inches (0.254 mm) to 1 inch (25.4 mm), or from 0.01 inches (0.254 mm) to 0.50 inches (12.7 mm), or from 0.01 inches (0.254 mm) to 0.10 inches (2.54 mm), or from 0.04 inches (1.016 mm) to 0.10 inches (2.54 mm), or from 0.05 inches (1.27 mm) to 0.10 inches (2.54 mm), or from 0.06 inches (1.524 mm) to 0.10 inches (2.54 mm); and/or
(m) the W_{PB}:W_{CBS} Ratio is from about 1.5:1 to about 10:1, or from about 1.5:1 to about 5:1, or from about 2:1 to about 5:1, or from about 2.5:1 to about 5:1, or from about 3:1 to about 5:1, or from about 1.5:1 to about 3:1; and/or
(n) the pin tip width, W_{PT}, is from 0.001 inches (0.0254 mm) to 2 inches (50.8 mm), or from 0.001 inches (0.0254 mm) to 1 inch (25.4 mm), or from 0.001 inches (0.0254 mm) to 0.50 inches (12.7 mm), or from 0.001 inches (0.0254 mm) to 0.10 inches (2.54 mm), or from 0.01 inches (0.254 mm) to 0.10 inches (2.54 mm), or from 0.02 inches (0.508 mm) to 0.10 inches (2.54 mm), or from 0.03 inches (0.762 mm) to 0.10 inches (2.54 mm), or 0.03 inches (0.762 mm) to 0.05 inches (1.27 mm); and/or
(o) the W_{PB}:W_{PT} Ratio is from about 1:1 to about 10:1, or from greater than about 1:1 to about 10:1, or from about 1.5:1 to about 10:1, or from about 1.5:1 to about 5:1, or from about 1.5:1 to about 2:1, or from about 2:1 to about 5:1; and/or
(p) the contactor 10 (including the annular wall 12 and the pins 30) is integral.

In other embodiments, the contactor may comprise: (i) an annular wall defining an annular passageway having a first end and a second end; (ii) a plurality of channels extending along a length of an inner surface of the annular wall, the plurality of channels extending along the length of the inner surface; and (iii) a plurality of pins positioned at the second end of the annular passageway, each pin having a length that extends from and substantially aligns with a channel of the plurality of channels.

The contactor may comprise two or more embodiments as disclosed herein.

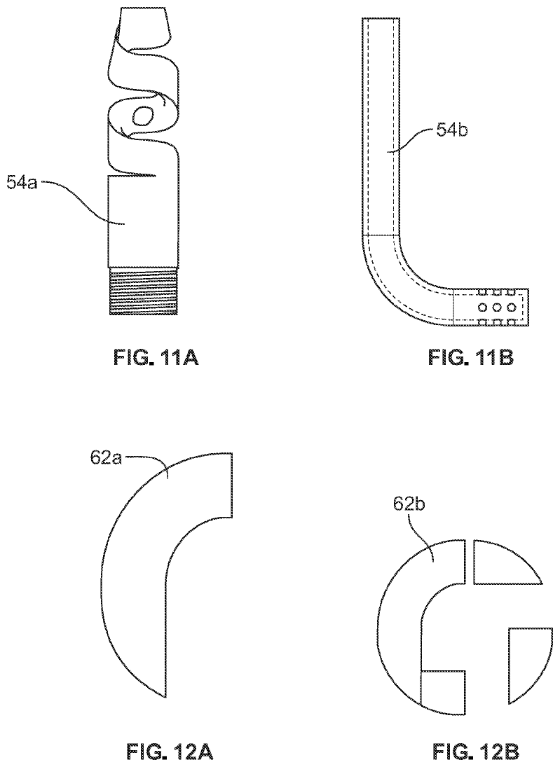

Now turning to FIG. 10, a system for extracting liquid-soluble compounds from a gas stream is also provided. The system includes (A) a contactor; (B) a gas feed stream comprising a gas and liquid-soluble compounds, the gas feed stream in fluid communication with the first end of the contactor; (C) a solvent feed stream comprising a solvent, the solvent feed stream in fluid communication with the first end of the contactor; and (D) a separation device in fluid communication with the second end of the contactor, the separation device configured to separate gas from solvent comprising the liquid-soluble compounds. Preferably, the contactor may be provided in the form of any of the embodiments of the contactor 10 disclosed herein and include at least one of the following: (i) an annular wall defining an annular passageway having a diameter, the diameter at a first end of the annular passageway being greater than the diameter at a second end of the annular passageway; (ii) a plurality of channels extending along a length of an inner surface of the annular wall; and (iii) a plurality of pins positioned at the second end of the annular passageway, each pin having a length that extends from and substantially aligns with a channel.

The system includes a gas feed stream containing (i) a gas and (ii) liquid-soluble compounds. Nonlimiting examples of gas feed streams include natural gas and flue gas.

In an embodiment, the gas feed stream is a natural gas stream. Natural gas is a hydrocarbon gas that contains a majority amount of methane (in gas form). Natural gas may also contain one or more of methanol, methane, ethane, propane, butane, pentane, carbon dioxide, nitrogen, hydrogen sulfide, hydrogen chloride, helium, sulfur, water vapor, and combinations thereof. Methanol, carbon dioxide, hydrogen sulfide, and hydrogen chloride are liquid-soluble compounds. The natural gas may or may not be treated before being fed into the system.

In an embodiment, the gas feed stream is a flue gas stream. Flue gas is the gas exiting to the atmosphere via a flue, which is a pipe or channel for conveying exhaust gases from a fireplace, oven, furnace, boiler, or steam generator. Flue gas may also be the combustion exhaust gas produced at industrial facilities, such as power plants. Flue gas contains nitrogen (in gas form). Flue gas may also contain carbon dioxide, water vapor, oxygen, soot, carbon monoxide, nitrogen oxides, sulfur oxides, hydrogen sulfide, hydrogen chloride, and combinations thereof. Carbon dioxide, hydrogen sulfide, and hydrogen chloride are liquid-soluble compounds. The flue gas may or may not be treated before being fed into the system.

Still referring to FIG. 10, the gas feed stream 50 is in fluid communication with the first end 20 of the contactor 10. In some embodiments, the contactor 10 may be placed in a pipe 44. Consequently, the gas feed stream 50 flows into the pipe 44 and through the annular passageway 14 of the contactor 10.

The system 100 includes a solvent feed stream containing a solvent. The solvent feed stream 52 is in fluid communication with the first end 20 of the contactor 10. Nonlimiting examples of suitable solvents include triazine, caustic, alkali, nitrite, formaldehyde, ethanedial, amine sulfide, chelated iron, MDEA (methyldiethanolamine), water, hydrocarbon oil (e.g., kerosene) and combinations thereof. The solvent may be provided as a liquid. In addition, the solvent may be provided in varying concentrations (e.g., 4% by weight caustic or 25% by weight caustic) such that contaminants may be efficiently removed from the gas feed stream 50.

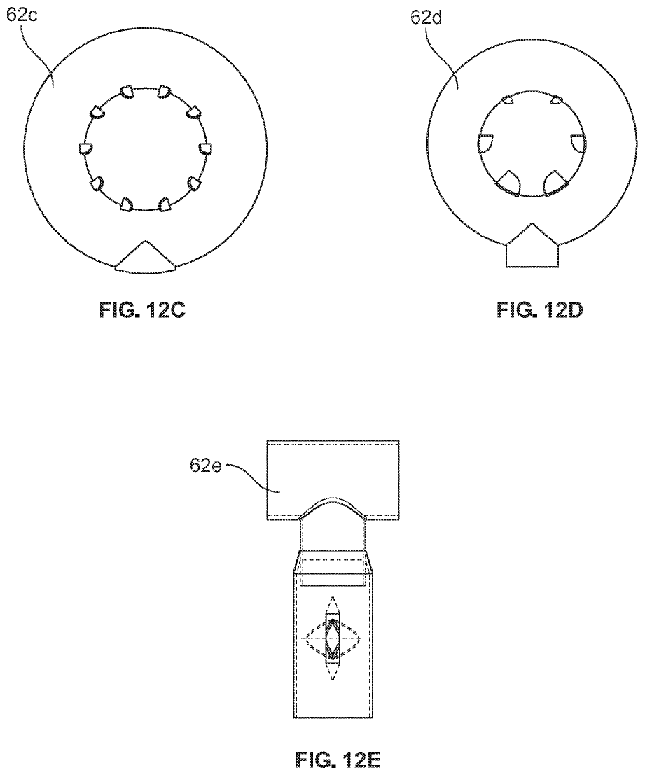

In some embodiments, an injector 54 places the solvent feed stream 52 in fluid communication with the first end 20 of the contactor 10. In an embodiment, the injector 54 extends into the pipe 44, up-stream of the contactor 10 and down-steam of the gas feed stream 50 inlet. Nonlimiting examples of suitable injectors 54 include direct pipe injectors, clog-free spray nozzles, elbow injectors, single nozzle injectors, dual nozzle injectors, tee injectors, dual tee injectors, quad tee injectors, perforated pipe injectors, spiral nozzle injectors, injectors that are integral with contactors 10 and combinations thereof. In an embodiment, the injector 54 is selected from elbow injectors, single nozzle injectors, dual nozzle injectors, dual tee injectors, quad tee injectors, perforated pipe injectors, spiral nozzle injectors, injectors that are integral with the contactor 10, and combinations thereof. In some embodiments, the injector 54 is a spiral nozzle injector. A nonlimiting example of a suitable spiral nozzle injector 54a is shown in FIG. 11A. In some embodiments, the injector 54 is a perforated pipe injector. A nonlimiting example of a suitable perforated pipe injector 54b is shown in FIG. 11B.

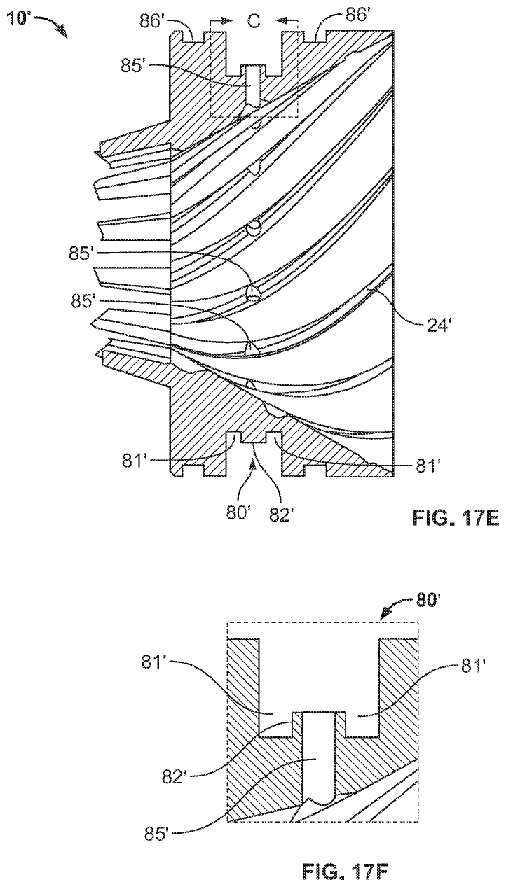

In another embodiment, an injector places the solvent feed stream directly into the contactor 10′. In such an embodiment, as shown in FIGS. 17A-F, the contactor 10′ is structurally similar to the contactor 10, but is modified to be in fluid communication with an injector. Specifically, the outer surface 16′ of the annular wall 12′ of the contactor 10′, instead of being smooth as in FIG. 1, contains a main groove 80′ around a portion of the annular wall 12′. The groove 80′ itself is composed of a number of individual contours, including a central raised portion 82′ with a minor groove 81′ on either side. Additional minor grooves 86′ for containing o-rings are provided on either side of the main groove 80′.

Each channel 24′ has a corresponding opening 85′ which extends through the annular wall 12′, and more specifically the raised portion 82′ of the main groove 80′ to create a passage from the outer surface 16′ through the contactor 10′ to the inner surface 18′. In the embodiment shown, each channel 24′ has a corresponding single opening 85′ and each of the openings 85′ are of the same diameter and open to the channel 24′ at the same angle. In further embodiments, however, each channel may have more than one opening or not every channel may have an opening. In still further embodiments, openings can be of varying sizes and open into the channels at different angles. When solvent is fed directly into the contactor 10′, the injector provides the solvent feed stream to the main groove 80′, where it enters the contactor 10′ at the channels 24′ through openings 85′.

Referring again to FIG. 10, as the gas feed stream 50 and the solvent feed stream 52 flow through the annular passageway 14 of the contactor 10, from the first end 20 to the second end 22, the solvent (liquid phase) will coalesce and re-entrain in the channels 24. The solvent flows through the channels 24 and is directed towards the pins 30 that are aligned with the channels 24. The pins 30 function as droplet nucleation sites (which disperses the solvent as droplets into the gas phase) and promote back-mixing of the stream to enhance contact time between the solvent and the gas feed stream. Thus, the contactor 10 increases the interfacial area between the gas phase and the liquid phase by dispersing droplets of the liquid phase within the gas phase. Further, the channels 24 that extend along an annular passageway 14 having a conical shape advantageously increase the velocity of the stream.

In some embodiments, passing the gas feed stream 50 and the solvent feed stream 52 through the annular passageway 14 of the contactor 10 forms droplets (in a liquid form) suspended in the gas. The droplets contain the solvent. An aerosol stream 58 in fluid communication with the second end 22 of the contactor 10 contains the droplets suspended in the gas. In some embodiments, the droplets have an average size of from greater than 0 μm to 300 μm, or from 1 μm to 20 μm. In another embodiment, the droplets have an average size of from 1 μm, or 2 μm, or 5 μm to 10 μm, or 15 μm, or 20 μm, or 100 μm, or 200 μm, or 300 μm. In some embodiments, the gas of the aerosol stream 58 has an average velocity of from 1 meter per second (m/s) to 20 m/s, or from 5 m/s to 15 m/s upon flowing from the second end 22 of the contactor 10. In another embodiment, the gas of the aerosol stream 58 has an average velocity of from 1 m/s, or 5 m/s, or 10 m/s to 15 m/s, or 20 m/s upon flowing from the second end 22 of the contactor 10.

Not wishing to be bound by any particular theory, it is believed that while the droplets are suspended in the gas within the aerosol stream 58, the droplets (which contain solvent) absorb the liquid-soluble compounds from the gas to form contaminated droplets. The contaminated droplets contain solvent and liquid-soluble compounds.

The system 100 further includes a separation device 56 in fluid communication with the second end 22 of the contactor 10. The separation device 56 is configured to separate gas from solvent containing the liquid-soluble compounds. In other words, the separation device 56 separates contaminated droplets (containing solvent and liquid-soluble compounds) from the gas in the aerosol stream. The separation device 56 is in fluid communication with the aerosol stream 58. Nonlimiting examples of suitable separation devices 56 include coalescers, bulk separation devices, centrifugal separation devices, knockout drums, and combinations thereof.

In some embodiments, the separation device 56 is a coalescer 60. A nonlimiting example of a suitable coalescer 60 is described in U.S. Pat. No. 8,425,663, the entire contents of which are incorporated herein by reference.

In some embodiments, the separation device 56 is a bulk separation device 62. Nonlimiting examples of suitable bulk separation devices 62 include elbow separators, spiral separators, ring separators, tee separators, and combinations thereof.

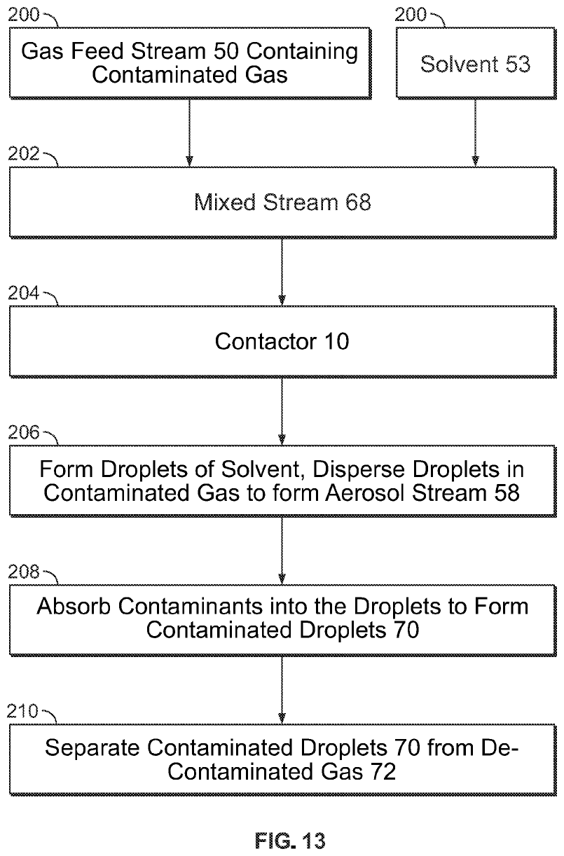

In an embodiment, the bulk separation device 62 is an elbow separator 62a, an example of which is depicted in FIG. 12A.

In an embodiment, the bulk separation device 62 is a spiral separator 62b, an example of which is depicted in FIG. 12B.

In an embodiment, the bulk separation device 62 is a ring separator 62c, 62d. Nonlimiting examples of suitable ring separators 62c, 62d are depicted in FIGS. 12C and 12D.

In an embodiment, the bulk separation device 62 is a tee-separator 62e, an example of which is depicted in FIG. 12E.

In some embodiments, the separation device 56 includes (i) a bulk separation device 62 in fluid communication with the second end 22 of the contactor 10; and (ii) a coalescer 60 in fluid communication with the bulk separation device 62. The bulk separation device 62 and the coalescer 60 are both configured to separate gas from solvent comprising the liquid-soluble compounds. The bulk separation device 62 and the coalescer 60 may or may not be contained within the same vessel. In an embodiment, the bulk separation device 62 and the coalescer 60 are separate units, and the coalescer 60 is downstream from the bulk separation device 62. In another embodiment, the bulk separation device 62 and the coalescer 60 are contained within a single vessel, the coalescer 60 is downstream from the bulk separation device 62.

Not wishing to be bound by any particular theory, it is believed that passing the aerosol stream 58 through the bulk separation device 62 and then the coalescer 60 results in more effective separation of the gas from solvent containing the liquid-soluble compounds relative to systems that use only a coalescer 60, or only a knockout drum.

In some embodiments, the bulk separation device 62 removes at least 60%, or at least 70%, or at least 75%, or at least 80% of the liquid-phase (i.e., the solvent containing the liquid-soluble compounds) from the aerosol stream 58. In another embodiment, the bulk separation device 62 removes from 60%, or 70%, or 75%, or 80% to 99.9%, or 100% of the liquid-phase (i.e., the solvent containing the liquid-soluble compounds) from the aerosol stream 58.

In some embodiments, the separation device 56 removes at least 60%, or at least 70%, or at least 75%, or at least 80% of the liquid-phase (i.e., the solvent containing the liquid-soluble compounds) from the aerosol stream 58. In another embodiment, the separation device 56 removes from 60%, or 70%, or 75%, or 80% to 99.9%, or 100% of the liquid-phase (i.e., the solvent containing the liquid-soluble compounds) from the aerosol stream 58. In some embodiments, the separated liquid phase (i.e., the solvent containing the liquid-soluble compounds) is discharged from the separation device 56 as a waste stream 64. The gas that has been separated from the liquid phase is vented through a gas line 66, and may be collected.

Not wishing to be bound by any particular theory, it is believed that passing (i) contaminated gas containing liquid-soluble compounds and (ii) solvent through the contactor 10 disperses the solvent as droplets in the contaminated gas such that the interfacial area between the liquid phase and the gas phase is maximized (as evidenced by a small droplet size), which enables more efficient absorption of the liquid-soluble compounds into the liquid phase. By then separating the contaminated liquid phase from the gas with a separation device 56, the resulting gas is advantageously void, or substantially void, of liquid-soluble compounds.

In an embodiment, multiple systems may be provided in series, e.g., one after another. In another embodiment, a system may include multiple contactors provided in series, e.g., one after another, in a single system.

The system may comprise two or more embodiments disclosed herein.

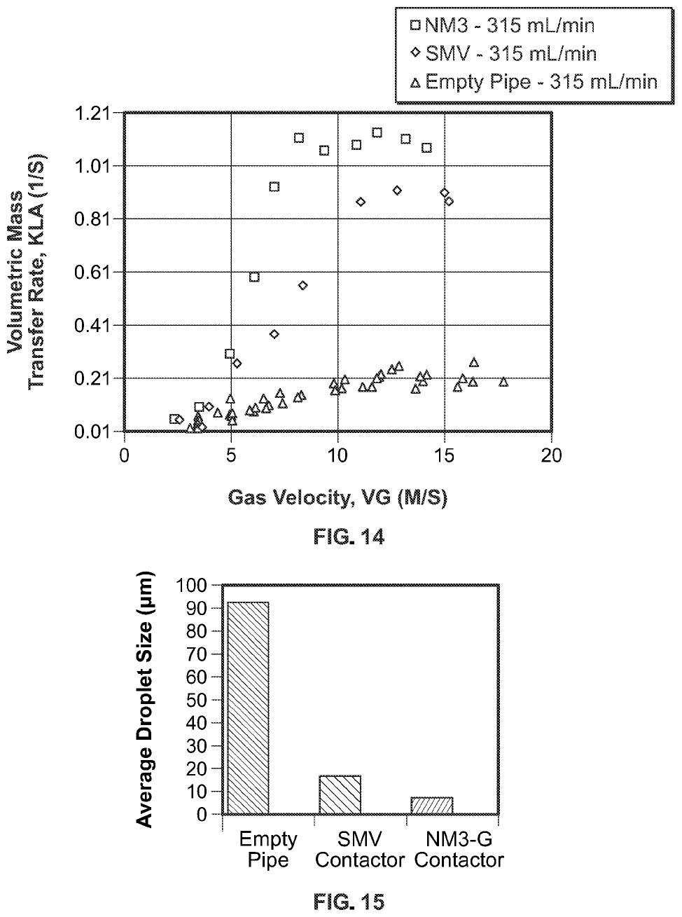

Turning to FIG. 13, a method for extracting liquid-soluble compounds from a gas stream is provided. The method includes (A) providing a gas feed stream comprising a gas and liquid-soluble compounds; (B) injecting a solvent into the gas feed stream to form a mixed stream; (C) passing the mixed stream through a contactor having (i) an annular wall defining an annular passageway having a diameter, the diameter at a first end of the annular passageway being greater than the diameter at a second end of the annular passageway; (ii) a plurality of channels extending along a length of an inner surface of the annular wall, the channels extending in a helical pattern along the length of the inner surface; and (iii) a plurality of pins positioned at the second end of the annular passageway, each pin having a length that extends from and substantially aligns with a channel; (D) forming droplets comprising the solvent with the plurality of pins; (E) absorbing the liquid-soluble compounds into the droplets to form contaminated droplets; and (F) separating the contaminated droplets from the gas.

The gas feed stream, solvent, and contactor may be any gas feed stream, solvent, and contactor disclosed herein.

As shown in FIG. 13, an embodiment of the method is provided. The illustrated method includes providing a gas feed stream 50 containing contaminated gas (i.e., a mixture of gas and liquid-soluble compounds) and injecting a solvent 53 into the gas feed stream 50 in a step 200. The solvent 53 may be any solvent disclosed herein. The injection of the solvent 53 into the gas feed stream 50 forms a mixed stream 68 in a step 202. In a step 204, the mixed steam 68 is passed through a contactor 10. In some embodiments, a step 206 is provided wherein droplets of solvent are formed on the plurality of pins 30 of the contactor 10, and the droplets are dispersed in the contaminated gas to form an aerosol stream 58. In a step 208, the contaminants of the contaminated gas are absorbed into the droplets to form contaminated droplets 70. In some embodiments, the method includes a step wherein the absorption results in a mixture of contaminated droplets 70 and de-contaminated gas 72. Then, in a step 210, the contaminated droplets 70 are then separated from the de-contaminated gas 72. The contaminated droplets 70 may be separated from the de-contaminated gas 72 with a separation device 56. The separation device 56 may be any separation device 56 disclosed herein.

In some embodiments, the droplets formed on the plurality of pins 30 have an average size of from greater than 0 μm to 300 μm, or from 1 μm to 20 μm. In another embodiment, the droplets formed on the plurality of pins 30 have an average size of from 1 μm, or 2 μm, or 5 μm to 10 μm, or 15 μm, or 20 μm, or 100 μm, or 200 μm, or 300 μm. In some embodiments, the gas of the aerosol stream 58 has an average velocity of from 1 meter per second (m/s) to 20 m/s, or from 5 m/s to 15 m/s upon flowing from the second end 22 of the contactor 10. In another embodiment, the gas of the aerosol stream 58 has an average velocity of from 1 m/s, or 5 m/s, or 10 m/s to 15 m/s, or 20 m/s upon flowing from the second end 22 of the contactor 10.

The method may comprise two or more embodiments disclosed herein.

By way of example, and not limitation, examples of the present disclosure are provided.

### EXAMPLES

An Example Contactor is formed from Grade 316 stainless steel in accordance with FIGS. 1-9. The dimensions of the contactor are shown in Table 1.

TABLE 1

| | Abbre- | | |
|---|---|---|---|
| Dimension | viation | Value | |
| channel opening width | W_{CO} | 0.062 | inch |
| channel bottom surface width | W_{CBS} | 0.020 | inch |
| diameter of first end of the annular passageway | D₁ | 1 | inch |
| diameter of second end of the annular passageway | D₂ | 0.430 | inch |
| length of the outer surface of the annular wall | L_{OS} | 0.50 | inch |
| pin tip width | W_{PT} | 0.030 | inch |
| pin base width | W_{PB} | 0.060 | inch |
| pin length | L_{P} | 0.18 | inch |

| | | |
|---|---|---|
| angle between opposing side surfaces of the | A | 120° |
| channel and the channel bottom surface | | |
| angle between the inner surface of the annular | B | 31° |
| wall and the outer surface of the annular wall | | |
| angle between pin bottom surface and the | C | 108° |
| second end of the annular wall | | |

A corrugated plate static mixer is utilized as a Comparative Contactor. The Sulzer SMV static mixer is formed from Grade 316 stainless steel.

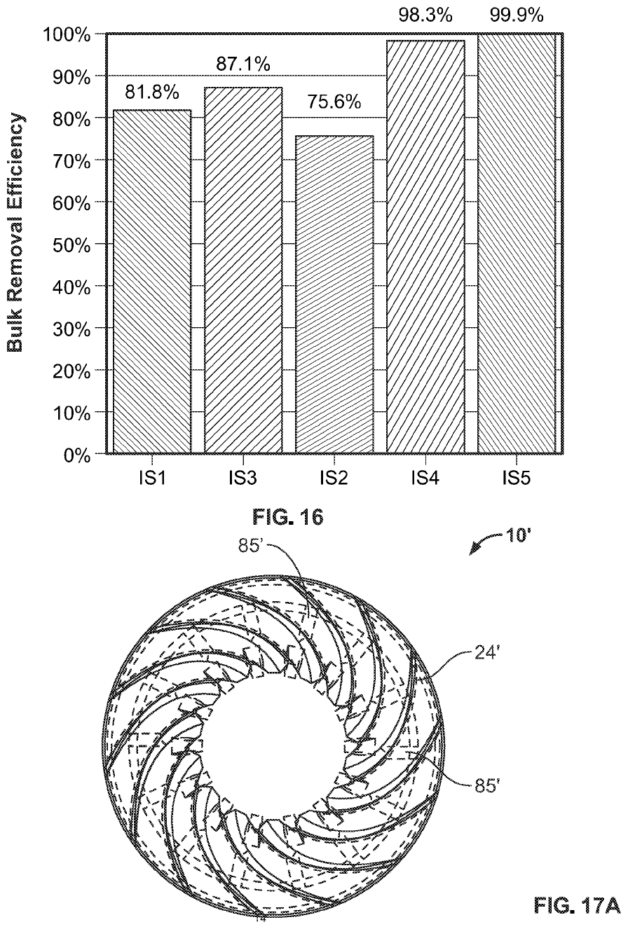

The system of FIG. 10 is arranged with the Example Contactor and the Comparative Contactor. The pipe as a pipe diameter, D_{P}, of 1 inch. Each of the Example Contactor and the Comparative Contactor is adhered to the pipe 44 with a high temperature epoxy adhesive and welds to form an Example System and a SMV Comparative System, respectively. A third system is prepared without a contactor (i.e., an Empty Pipe Comparative System). A gas feed stream containing carbon dioxide is fed into each system. The gas feed stream is fed into each system at a pressure of 120 psi and a temperature of 70° F. A solvent stream containing water and sodium hydroxide at a concentration of 1 mol/liter is injected into the pipe using a tee injector. The solvent is injected at a rate of 315 mL/min. The velocity of the gas entering the contactor, V_{g}, is measured. The volumetric mass transfer rate and interfacial area are measured using gas chromatography and liquid phase pH measurements. The results are shown in FIG. 14. In FIG. 14, “NM3” refers to the Example System and “SMV” refers to the SMV Comparative System.

The volumetric mass transfer coefficient (k_{L}a) is defined, in this example system, as the product of the interfacial area concentration (a) in units of m²/m³ and the liquid phase mass transfer coefficient (k_{L}) in units of m/s. Given the large difference in viscosity between the gas and liquid phases, the diffusion coefficient of the carbon dioxide in the gas is significantly higher than in the liquid phase. Therefore, the resistance to mass transfer resides in the liquid.

The volumetric mass transfer coefficient is calculated according to Eq. 1 by measuring the concentration of carbon dioxide at the inlet and outlet of the contactor while injecting pure water using gas chromatography and measurement of liquid phase pH. Nis the total flux of carbon dioxide form the gas phase to the liquid phase in units of mol/s. C*_{CO}_{₂}_{,in} is the concentration of carbon dioxide in the liquid at the interface between the gas and liquid phase at the inlet of the contactor in units of mol/m³. C*_{CO}_{₂}_{,out} is the concentration of carbon dioxide in the bulk liquid phase at the outlet of the contractor in units of mol/m³. Vis the total gas volume between the inlet and outlet sample point in units of m³. Conversions between gas and liquid concentrations are calculated by Henry's Law.

$${k}_{L} a = \frac{N}{V ( {C}_{{CO}_{2} , i n}^{*} - \frac{( {C}_{{CO}_{2} , i n}^{*} - {C}_{{CO}_{2} , out} )}{ln ( \frac{{C}_{{CO}_{2} , i n}}{{C}_{{CO}_{2} , i n}^{*} - {C}_{{CO}_{2} , out}} )} )} \qquad ( Eq . 1 )$$

The interfacial area is calculated according to Eq. 2 by measuring the concentration of carbon dioxide at the inlet and outlet of the contactor while injecting water with sodium hydroxide at a concentration of 1 mol/liter using gas chromatography. N is the total flux of carbon dioxide from the gas phase to the liquid phase in units of mol/s. C*_{CO}_{₂}_{,in} and C*_{CO}_{₂}_{,out} is the concentration of carbon dioxide in the liquid at the interface between the gas and liquid phase at the inlet and outlet of the contactor, respectively, in units of mol/m³. V is the total gas volume between the inlet and outlet sample point in units of m³. D_{CO}_{₂} is the liquid phase diffusion coefficient of carbon dioxide. k is the reaction kinetic constant for the reaction between carbon dioxide and aqueous sodium hydroxide with units of m³/mol/s. C_{NαOH} is the concentration of sodium hydroxide in the solvent in units of mol/m³. Conversions between gas and liquid concentrations are calculated by Henry's Law.

$$a = \frac{N}{V ( \sqrt{{D}_{{CO}_{2}} k {C}_{NaOH}} \frac{( {C}_{{CO}_{2} , i n}^{*} - {C}_{{CO}_{2} , out}^{*} )}{ln ( \frac{{C}_{{CO}_{2} , i n}^{*}}{{C}_{{CO}_{2} , out}^{*}} )} )} \qquad ( Eq . 2 )$$

As shown in FIG. 14, the Example System advantageously exhibits a higher volumetric mass transfer rate than the SMV Comparative System and the Empty Pipe Comparative System at the same gas velocities.

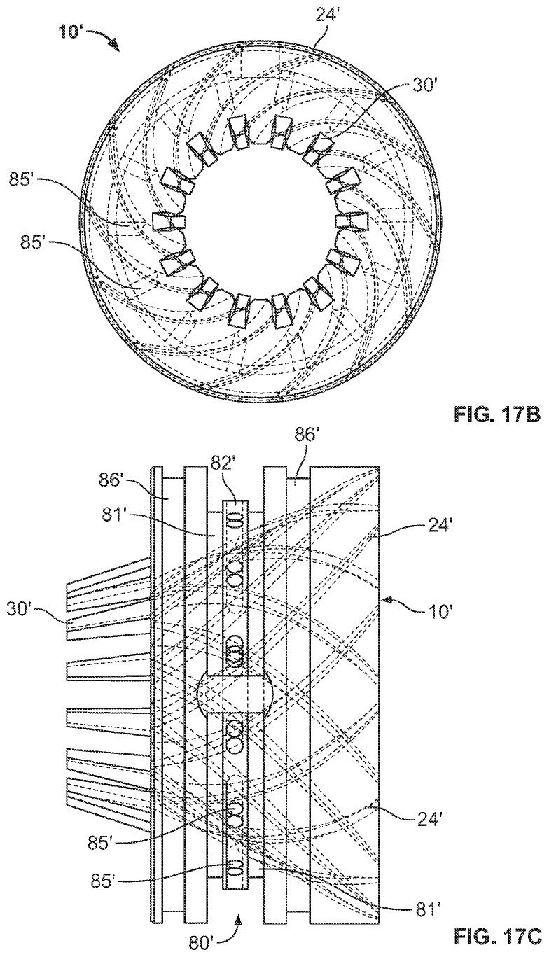

The average equivalent droplet size of the droplets formed by the Example System and Comparative System is calculated based on the interfacial area measurements. The results are shown in FIG. 15. As shown in FIG. 15, the Example System advantageously forms droplets with a smaller size relative to the SMV Comparative System and the Empty Pipe Comparative System. A smaller droplet size suggests that there is a higher interfacial area between the gas phase and the liquid phase, which is believed to result in improved absorption of contaminants in the gas phase into the liquid phase.

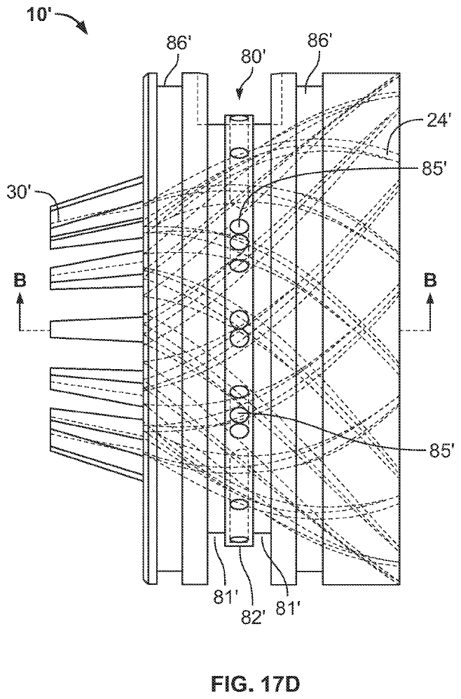

Using computational fluid dynamics simulation software, the Example System is configured with a bulk separation device upstream of a coalescer. The bulk separation devices of FIGS. 12A-12E are simulated using commercially available Euler-Lagrangian computational fluid dynamics methods that include liquid film and droplet physics. The amount of liquid phase removed by each bulk separation device is computed (as the volume percentage of liquid removed). The results are shown in FIG. 16. In FIG. 16, IS1 refers to an elbow separator 62a, IS2 refers to a spiral separator 62b, IS3 refers to a ring separator 62c, IS4 refers to a ring separator 62d, and IS5 refers to a tee-separator 62e. As shown each of the bulk separation devices removes over 70 vol % of the liquid phase from the stream containing contaminated droplets and de-contaminated gas (based on the total volume of droplets in the stream).

The Example System is also configured with the following injector types: elbow injector, single nozzle injector, dual nozzle injector, dual tee injector, quad tee injector, perforated pipe injector, injector that is integral with contactor, and spiral nozzle injector. Advantageously, it was discovered that the type of injector did not materially impact the size of the droplets formed by the pins.

A system for extracting liquid-soluble compounds from a gas stream is provided. The system includes (A) a contactor; (B) a gas feed stream comprising a gas and liquid-soluble compounds, the gas feed stream in fluid communication with the first end of the contactor; (C) a solvent feed stream comprising a solvent, the solvent feed stream in fluid communication with the first end of the contactor; and (D) a separation device in fluid communication with the second end of the contactor, the separation device configured to separate gas from solvent comprising the liquid-soluble compounds. Preferably, the contactor may include at least one of the following: (i) an annular wall defining an annular passageway having a diameter, the diameter at a first end of the annular passageway being greater than the diameter at a second end of the annular passageway; (ii) a plurality of channels extending along a length of an inner surface of the annular wall; and (iii) a plurality of pins positioned at the second end of the annular passageway, each pin having a length that extends from and substantially aligns with a channel.

In other embodiments, the method for extracting liquid-soluble compounds from a gas stream may comprise the steps of: (A) providing a gas feed stream; (B) injecting a solvent into the gas feed stream to form a mixed stream; and (C) passing the mixed stream through a contactor. In additional embodiments, the method may further comprise: (D) forming droplets comprising the solvent with the plurality of pins; (E) absorbing liquid-soluble compounds into the droplets to form contaminated droplets; and (F) separating the contaminated droplets from the gas feed stream. In alternative embodiments, steps (D) of the method may comprise forming droplets comprising the solvent using the contactor.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A contactor comprising:
an annular wall defining an annular passageway having a first end and a second end;
a plurality of channels extending along a length of an inner surface of the annular wall; and
a plurality of pins positioned at the second end of the annular passageway, each pin having a length that extends from and substantially aligns with a channel of the plurality of channels.

2. The contactor of claim 1, wherein the annular passageway has a diameter, and the diameter at the first end of the annular passageway is greater than the diameter at the second end of the annular passageway.

3. The contactor of claim 1, wherein the plurality of channels extend along the length of the inner surface in a pattern, and the pattern is selected from a group consisting of a helical pattern, a parallel pattern, a sinusoidal pattern, and combinations thereof.

4. The contactor of claim 1, wherein the plurality of channels protrude radially inward from the annular wall.

5. The contactor of claim 1, wherein each channel of the plurality of channels has a cross-sectional shape selected from a group consisting of a polygonal shape, an ellipse, and combinations thereof.

6. The contactor of claim 1, wherein the annular wall has a wall length, and a ratio of the wall length to a diameter of the annular passageway at the second end is from about 0.5 to about 1.5.

7. The contactor of claim 1, wherein each channel of the plurality of channels has a bottom surface, each pin of the plurality of pins has a top surface, and each channel bottom surface is aligned with a pin top surface.

8. The contactor of claim 1, wherein a number of channels provided in the plurality of channels is equal to a number of pins provided in the plurality of pins.

9. The contactor of claim 1, wherein the inner surface of the annular wall has a taper angle of from about 5° to less than about 90°.

10. The contactor of claim 1, wherein the plurality of pins are configured to provide a droplet nucleation site for a stream comprising a gas phase and a liquid phase flowing through the contactor.

11. The contactor of claim 1, wherein each pin of the plurality of pins has a cross-sectional shape selected from a group consisting of an ellipse, a circle, a polygon, and combinations thereof.

12. The contactor of claim 11, wherein the cross-sectional shape of each pin of the plurality of pins is the same.

13. A method for extracting liquid-soluble compounds from a gas stream, comprising:
(A) providing a gas feed stream;
(B) injecting a solvent into the gas feed stream to form a mixed stream; and
(C) passing the mixed stream through a contactor.

14. The method of claim 13, the method further comprising:
(D) forming droplets comprising the solvent with a plurality of pins;
(E) absorbing liquid-soluble compounds into the droplets to form contaminated droplets; and
(F) separating the contaminated droplets from the gas feed stream.

15. The method of claim 14, the method further comprising using a separation device configured to separate the contaminated droplets from the gas feed stream, the separation device including (i) a bulk separation device in fluid communication with an end of the contactor and (ii) a coalescer in fluid communication with the bulk separation device.

16. The method of claim 13, wherein the contactor further comprises:
(i) an annular wall defining an annular passageway having a diameter, the diameter at a first end of the annular passageway being greater than the diameter at a second end of the annular passageway; and
(ii) a plurality of pins positioned at the second end of the annular passageway.

17. The method of claim 13, wherein a plurality of pins are positioned such that the plurality of pins substantially align with a plurality of channels disposed upon an annular wall of the contactor.

18. The method of claim 13, wherein the contactor further comprises a plurality of channels extending along a length of an inner surface of an annular wall of the contactor, the plurality of channels extending in a pattern along the length of the inner surface.

19. A system for extracting liquid-soluble compounds from a gas stream comprising:
(A) a contactor comprising
(i) an annular wall defining an annular passageway having a diameter, the diameter at a first end of the annular passageway being greater than the diameter at a second end of the annular passageway; and
(ii) a plurality of channels extending along a length of an inner surface of the annular wall, the plurality of channels extending along the length of the inner surface;
(B) a gas feed stream comprising a gas and the liquid-soluble compounds, the gas feed stream in fluid communication with the first end of the contactor;
(C) a solvent feed stream comprising a solvent, the solvent feed stream in fluid communication with the first end of the contactor; and
(D) a separation device in fluid communication with the second end of the contactor, the separation device configured to separate the gas from the solvent comprising the liquid-soluble compounds.

20. The system of claim 19, wherein an injector places the solvent feed stream in fluid communication with the first end of the contactor and the contactor is configured to provide a droplet nucleation site for the solvent.
